(19) United States
(12) Patent Application Publication
(10) Pub. No.: US 2026/0114416 A1
(43) Pub. Date: Apr. 30, 2026

(54) FOOD CONTAINER ASSEMBLY

(71) Applicant: Loos Machine & Automation, LLC, Colby, WI (US)

(72) Inventors: Eric John Mertens, Colby, WI (US); Brady Lee Hoes, Colby, WI (US); Brian Robert Kaldunski, Marathon, WI (US); Thomas Francis Hoppe, II, Green Bay, WI (US)

(21) Appl. No.: 19/003,314

(22) Filed: Dec. 27, 2024

Related U.S. Application Data
(60) Provisional application No. 63/615,612, filed on Dec. 28, 2023.
(60) Provisional application No. 63/690,634, filed on Sep. 4, 2024.

(51) Int. Cl. A01J 25/00; A01J 25/11; A01J 25/16; B65D 85/76

(52) U.S. Cl. CPC A01J 25/004; A01J 25/001; A01J 25/111; A01J 25/162; B65D 85/76

(57) ABSTRACT

A food container configured to store a foodstuff therein, the food container including an inner structural layer at least partially defining an internal volume in which the foodstuff may be positioned and an outer structural layer located outside the inner structural layer relative to the internal volume. Where the outer structural layer is adjustable between an installed position, in which the outer structural layer encompasses and provides structural support to the inner structural layer, and a detached position where the outer structural layer does not encompass and does not provide structural support to the inner structural layer, and where the outer structural layer is adjustable between the installed position and the detached position without having to remove the foodstuff from the internal volume.

### CROSS-REFERENCE TO RELATED APPLICATIONS

This application claims priority to prior-filed, co-pending U.S. Provisional Patent Application No. 63/615,612 filed on Dec. 28, 2023 and co-pending U.S. Provisional Patent Application No. 63/690,634 filed on Sep. 4, 2024, the entire contents of which is incorporated herein by reference.

### FIELD

The disclosure relates to a container for the manufacture and shipping of blocks of foodstuff.

### BACKGROUND

When making cheese in large block format, large forces are exerted upon the container in which the cheese is made and aged during the cheesemaking process.

### SUMMARY

In one aspect, a food container configured to store a foodstuff therein, the food container including an inner structural layer at least partially defining an internal volume in which the foodstuff may be positioned, and an outer structural layer located outside the inner structural layer relative to the internal volume, where the outer structural layer is adjustable between an installed position, in which the outer structural layer encompasses and provides structural support to the inner structural layer, and a detached position where the outer structural layer does not encompass and does not provide structural support to the inner structural layer, and where the outer structural layer is adjustable between the installed position and the detached position.

Alternatively or additionally, where the outer structural layer is adjustable between the installed position and the detached position without having to remove the foodstuff from the internal volume.

Alternatively or additionally, where the inner structural layer is formed from a paperboard material.

Alternatively or additionally, where the outer structural layer is formed from a metallic material.

Alternatively or additionally, where the inner structural layer defines an exterior shape, and where the outer structural layer includes an inner shape that corresponds with the exterior shape when the outer structural layer is in the installed position.

Alternatively or additionally, where the outer structural layer is in direct contact with the inner structural layer when the outer structural layer is in the installed position.

Alternatively or additionally, where the inner structural layer includes two pieces of material coupled together to form the internal volume.

In another aspect, a disposable container configured to contain foodstuff therein, the disposable container including a body including a plurality of panels, where the body defines an interior volume in which foodstuff may be placed, where the interior volume is open on a first end, and where at least two of the panels overlap, and a first end cap couplable to the body, where the first end cap is configured to enclose the first end.

Alternatively or additionally, further including a liner at least partially positioned within the internal volume, where the liner is positioned to form a barrier between the foodstuff and the plurality of panels.

Alternatively or additionally, where the plurality of panels are formed from two U-shaped segments.

Alternatively or additionally, where the body and the first end cap are both formed from a paperboard material.

Alternatively or additionally, where the paperboard material is approximately ¼″ thick.

Alternatively or additionally, where at least one panel defines a sample port open to the internal volume.

Alternatively or additionally, where at least two panels of the plurality of panels are formed from a single piece of material.

Alternatively or additionally, where the first end cap includes a base plate and one or more side plates extending from the perimeter of the base plate to define a first end cap volume, and where the first end of the body is positioned within the first end cap volume.

Alternatively or additionally, where the interior volume is open on a second end opposite the first end, the container further comprising a second end cap couplable to the body and configured to enclose the second end.

Alternatively or additionally, further including a first plurality of panels, and where the first plurality of panels are removably positionable around the exterior of the body.

Alternatively or additionally, where internal volume has sufficient size and shape to contain a standard 640 lb. block of cheese therein.

Alternatively or additionally, where the inner structural layer includes a plurality of planar panels.

Alternatively or additionally, where the outer structural layer includes a plurality of planar panels.

Alternatively or additionally, further including a press board at least partially positioned within the internal volume.

In another aspect, a method of manufacturing a foodstuff, the method including providing a container having an inner structural layer that defines an interior volume and an outer structural layer that at least partially extends along the exterior of the inner structural layer, at least partially filling the interior volume with foodstuff, undergoing at least one food processing step with both the inner structural layer and the outer structural layer attached to the container, removing the outer structural layer from the container, and shipping the container with the outer structural layer removed.

Alternatively or additionally, where the inner structural layer is formed from paperboard.

Alternatively or additionally, where the outer structural layer is formed from a metallic material.

Alternatively or additionally, where at least partially filling the interior volume with foodstuff includes at least partially filling the interior volume with the ingredients for making cheese.

Alternatively or additionally, where undergoing at least one food processing step may include any one of whey extraction, pressing, tipping, vacuuming, and aging.

Alternatively or additionally, where the removing the outer structural layer from the container includes removing the outer structural layer without removing the foodstuff from the interior volume.

In another aspect, a disposable container configured to contain foodstuff therein, the disposable container including a plurality of structural sidewalls at least partially defining an internal volume in which the foodstuff may be placed, where the structural sidewalls are formed from a paperboard material, a liner at least partially positioned within the internal volume, where the liner is positioned to form a barrier between the foodstuff and the plurality of structural sidewalls, and at least one endcap enclosing at least one end of the plurality of structural sidewalls, and where the endcap is formed from a paperboard material.

Alternatively or additionally, where internal volume has sufficient size and shape to contain a standard 640 lb. block of cheese therein.

Alternatively or additionally, where the plurality of structural sidewalls are formed from two U-shaped segments having three panels each.

Alternatively or additionally, where the paperboard material forming the plurality of structural sidewalls is approximately ¼″ thick.

In another aspect, a container configured to contain foodstuff therein, the container including a first segment including two or more panels formed from a single piece of material, a second segment including two or more panels formed from a single piece of material, where the first segment and the second segment define an interior volume that is open on at least one end.

Alternatively or additionally, where the first segment includes three panels separated by two joints.

Alternatively or additionally, where the first segment includes a first central panel, a first side panel adjacent the first central panel, and a second side panel adjacent the first central panel opposite the first side panel, where the second segment includes a second central panel, a third side panel adjacent the second central panel, and a fourth side panel adjacent the second central panel opposite the third side panel, and where the first segment is coupled to the second segment such that the first side panel overlaps the third side panel and where the second side panel overlaps the fourth side panel.

Alternatively or additionally, where the second segment includes three panels separated by two joints.

Alternatively or additionally, further including a first end cap configured to enclose the at least one end.

In another aspect, a container configured to contain foodstuff, the container including a body at least partially defining an interior volume open at a first end, where the body defines a first axis passing through the first end of the interior volume and a first reference plane oriented normal to the first axis, where the body defines a first cross-sectional shape taken along the first reference plane, and where the body is adjustable between an open configuration, in which the first cross-sectional shape is open in at least one location, and a closed configuration, in which the first cross-sectional shape completely encloses the interior volume.

Alternatively or additionally, further including a first end cap configured to enclose the first end of the body.

Alternatively or additionally, further including a second end cap configured to enclose a second end of the body opposite the first end of the body.

Alternatively or additionally, where the body includes a first segment including one or more panels, and a second segment including one or more panels, and wherein the body is adjustable between the open and closed configurations by removing and adding the first segment.

Alternatively or additionally, where the body includes one or more panels, and wherein the body is adjustable between the open and closed configurations by moving the one or more panels relative to each other.

### BRIEF DESCRIPTION OF THE DRAWINGS

FIG. 1 is a perspective view of the food container assembly.

FIG. 2 is a section view taken along line 2-2 of FIG. 1.

FIG. 3 is a detailed view of a top region of the food container assembly from the section view of FIG. 2.

FIG. 4 is a detailed view of a bottom region of the food container assembly from the section view of FIG. 2.

FIG. 5 is a top perspective view of the base of the food container assembly of FIG. 1.

FIG. 6 is a bottom perspective view of the base of FIG. 5.

FIG. 7 is a perspective view of a container in the shipping configuration.

FIG. 8 is a perspective view of the inner structural layer of the container of FIG. 7.

FIG. 8A is a perspective view of a segment of the inner structural layer of the container of FIG. 7.

FIGS. 8B-8D illustrate different layout embodiments of the inner structural layer.

FIG. 9 is a detailed perspective view of the container of FIG. 7.

FIG. 10 is a perspective view of a container in the manufacturing configuration.

FIG. 11 is a section view taken along line 11-11 of FIG. 10.

FIG. 12 illustrates the container of FIG. 11 with a liner installed thereon.

FIG. 13 is a detailed view of a top region of the food container of FIG. 11.

FIG. 14 is a perspective view of a slot-style panel of the outer structural layer of the container of FIG. 10.

FIG. 15 is a front view of the panel of FIG. 14.

FIG. 16 is a side view of the panel of FIG. 14.

FIG. 17 is a perspective view of another embodiment of a hook-style panel of the outer structural layer of the container of FIG. 10.

FIG. 18 is a front view of the panel of FIG. 17.

FIG. 19 is a top perspective view of top cap of the food container assembly of FIG. 1.

FIG. 20 is a bottom perspective view of the top cap of FIG. 19.

FIG. 21 is a perspective view of the container in a shipping configuration.

FIG. 22 is a section view taken along line 22-22 of FIG. 21.

FIGS. 23A-23F illustrate a process of manufacturing and shipping a foodstuff using the food container assembly of FIG. 1.

FIGS. 24A-24F illustrate another process of manufacturing and shipping a foodstuff using the inner structural layer of the container of FIG. 21.

FIGS. 25A-25D illustrate another shipping process using the inner structural layer of the container of FIG. 21.

FIGS. 26A-26F illustrate another process of manufacturing and shipping a foodstuff using the inner structural layer of the container of FIG. 21.

FIG. 27 is a top perspective view of another embodiment of a food container assembly.

FIG. 28 is a side view of the food container assembly of FIG. 27.

FIG. 29 is a section view taken along line 29-29 of FIG. 27.

FIG. 30 is a detailed view of the section view of FIG. 29.

FIG. 31 illustrates an inner structural layer from the food container assembly of FIG. 27 with a first band installed thereon.

FIG. 32 illustrates an inner structural layer from the food container assembly of FIG. 27 with a first band and a plurality of panels installed thereon.

FIG. 33 is a perspective view of a panel from the food container assembly of FIG. 27.

FIG. 34 is a section view taken along line 34-34 of FIG. 33.

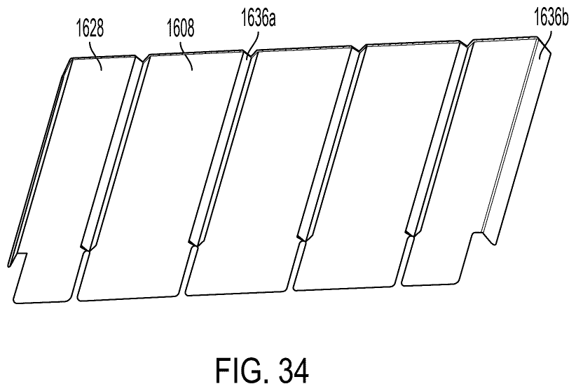

FIG. 35 is a perspective view of another embodiment of a container in a shipping configuration.

FIG. 36 is a section view taken along line 36-36 of FIG. 35.

FIG. 37 illustrates two containers of FIG. 35 stacked vertically upon each other.

FIG. 38 is a perspective view of the inner structural layer of FIG. 1 with another embodiment of a travel cap installed thereon.

FIG. 39 is the combination of FIG. 38 with straps installed thereon.

FIG. 40 is a detailed section view of the connection between adjacent side panels of the travel cap of FIG. 38.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways.

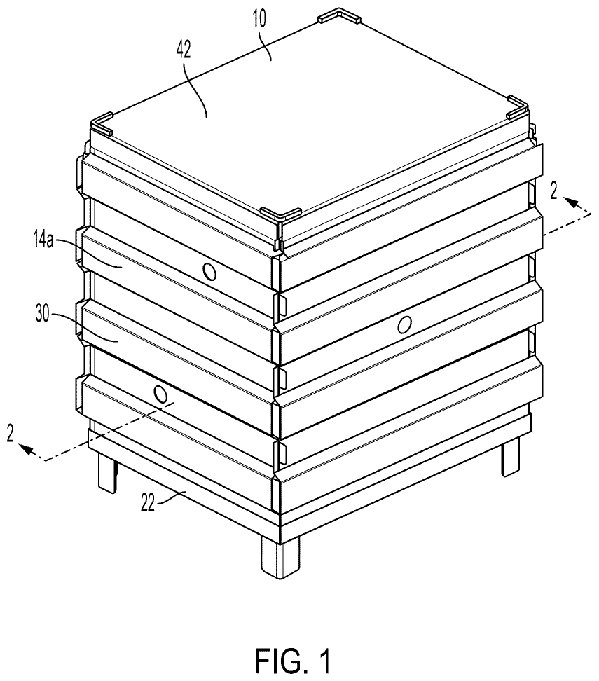

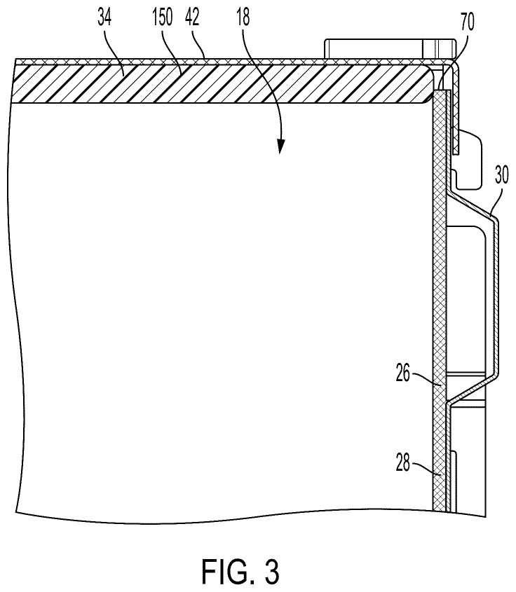

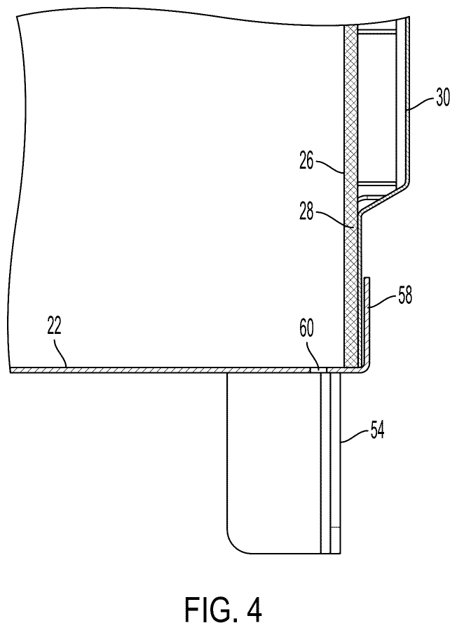

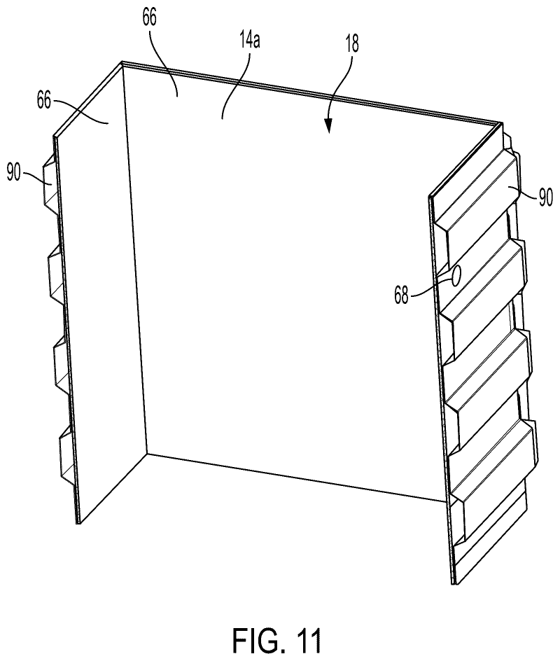

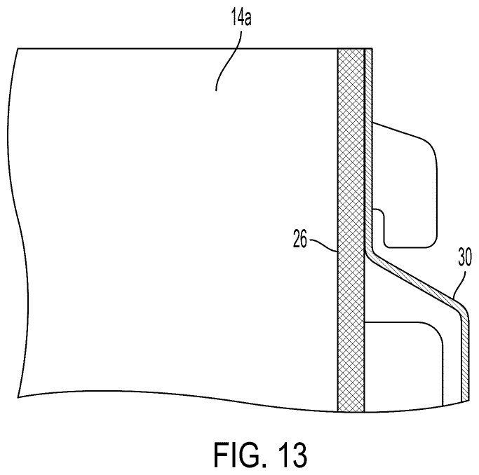

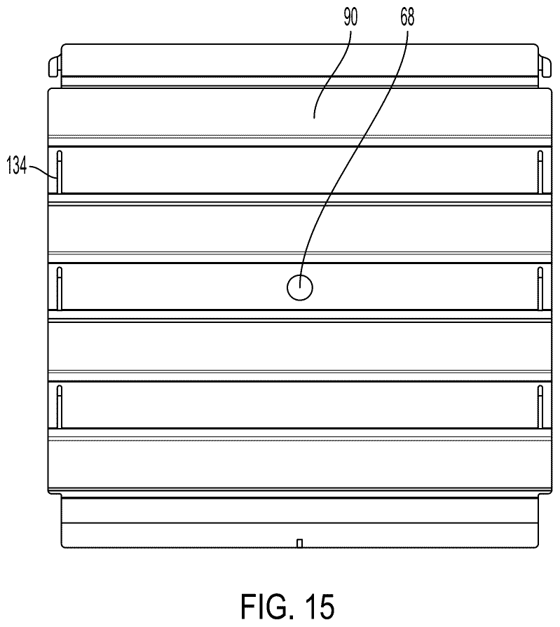

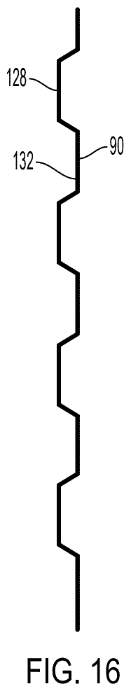

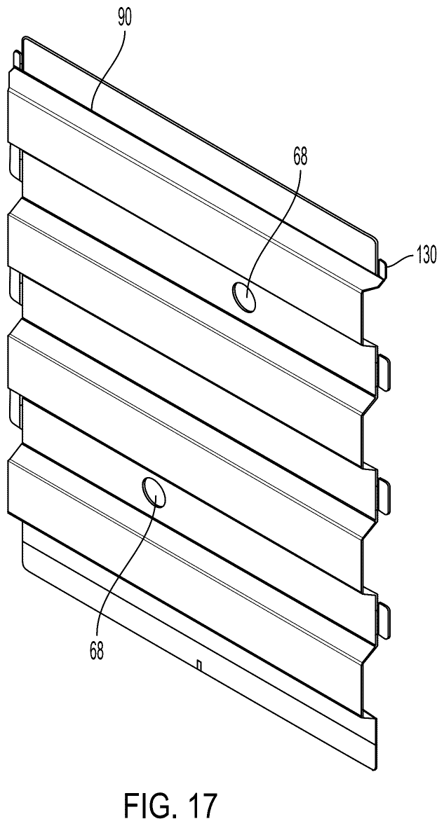

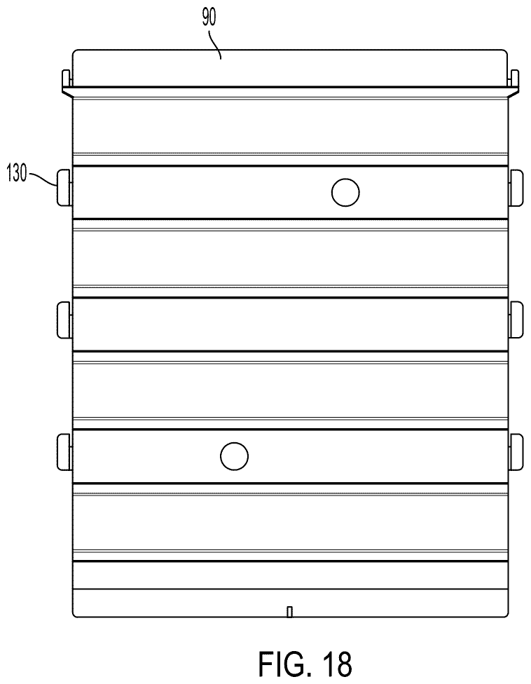

FIGS. 1-21 illustrate a food container assembly 10 for the manufacture and shipping of foodstuffs such as large or individually wrapped cheese blocks. More specifically, the food container assembly 10 includes a re-configurable container 14 having an interior volume 18 in which the inputs or ingredients for the foodstuff (e.g., milk, curd, and the like) may be placed and subsequently manufactured into a final product for shipping. The container 14, in turn, is operable in a first or manufacturing configuration, where the container 14a has the strength and rigidity necessary to accommodate the manufacturing processes for preparing and making the desired foodstuff, and a second or shipping configuration, in which the container 14b contains a minimal amount of material and weight to allow the resulting foodstuff to be shipped to the end user at low cost. The container 14 is further configured so that it can be modified from the first configuration to the second configuration without having to remove the finished foodstuff from the interior volume 18 thereof. In some configurations, when the container 14 is in the shipping configuration the resulting container 14b is a one-time-use or “disposable” container in the sense that the container 14b need not be returned to the manufacturer for reuse further saving cost.

The food container assembly 10 includes a base 22, an inner structural layer 26, an outer structural layer 30, a press assembly 34, and a top cap 42. The food container assembly 10 may also include one or more liners 46, 48 to help protect and contain the foodstuff during the manufacturing and shipping processes. Together, the above listed elements can be assembled to produce the container 14 in its various configurations 14a, 14b. More specifically, the individual elements can be manipulated and re-arranged to re-configure the container 14 between the manufacturing configuration 14a and the shipping configuration 14b without having to remove the foodstuff from the internal volume 18 thereof. In the illustrated embodiment, the internal volume 18 has sufficient size and shape to contain a standard 640 lb. block of cheese therein.

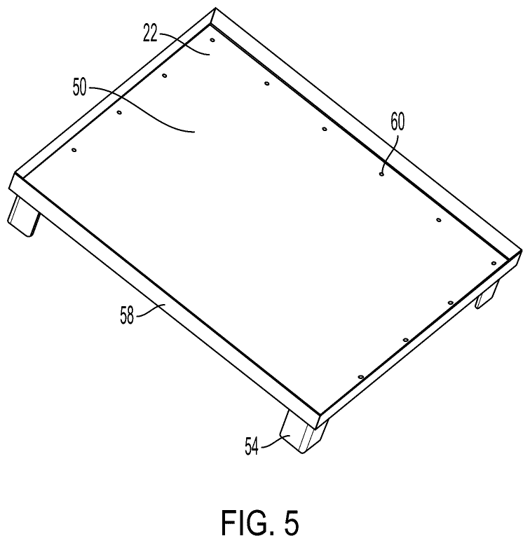

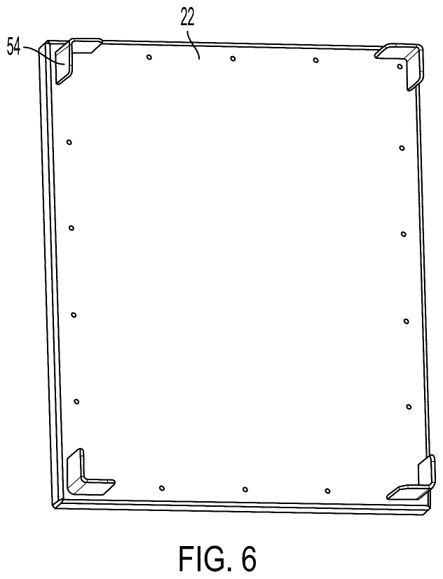

As shown in FIGS. 5 and 6, the base 22 of the food container assembly 10 is a platform upon which the inner and outer layers 26, 30 may be placed during the manufacturing process. The base 22 includes a platform 50 and a plurality of legs 54 extending from the platform 50 to elevate and distance the underside of the interior volume 18 from a support surface, stacked container 14, and the like. The platform 50, in turn, is substantially planar and has an exterior perimeter shape that substantially corresponds to the exterior shape of the exterior layer 30 (e.g., rectangular). The platform 50 also includes a perimeter or retaining wall 58 extending from the perimeter of the platform 50 sized to help retain and position the outer layer 30 relative to the base 22 during the manufacturing process.

As shown in FIG. 5, the base 22 also defines a plurality of apertures 60 formed into the platform 50 to allow whey and other liquids to drain from the interior volume 18 of the container 14 when positioned thereon. In the illustrated embodiment, the apertures 60 are positioned along the perimeter of the platform 50, but it is understood that in other embodiments the apertures 60 may be placed at other locations thereon to help aid the drainage of excess whey and other liquids from the interior volume 18 of the container 14.

The legs 54 of the base 22 are positioned proximate the corners of the platform 50. In the illustrated embodiment, the legs 54 are sized, shaped, and positioned to allow stacking atop other container assemblies 10 for more efficient use of warehouse and storage space. More specifically, the legs 54 are sized and placed so that they interact (e.g., nest within) corresponding stacking lips 64 extending from the top cap 42 (discussed below). By doing so, the interaction between the legs 54 and lips 64 assure that the container 14 stacked atop an adjacent container 14 will not slide or shift. In the illustrated embodiment, each leg 54 has a substantially “L” cross-sectional shape although in other embodiments different sizes and shapes may be used.

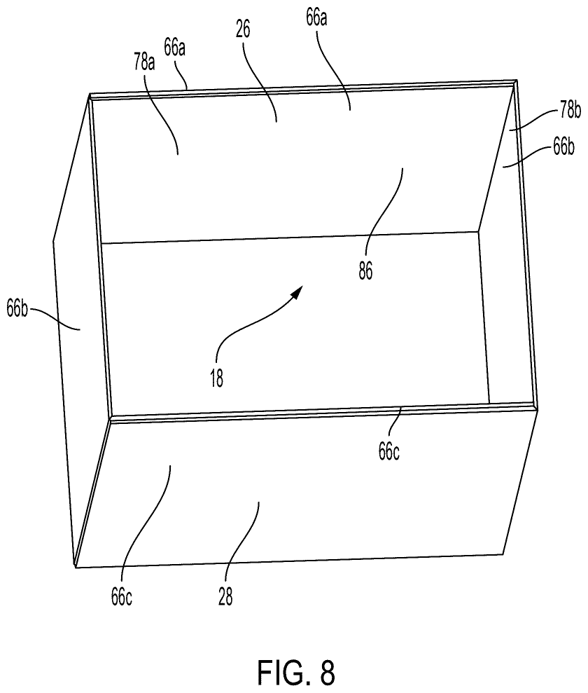

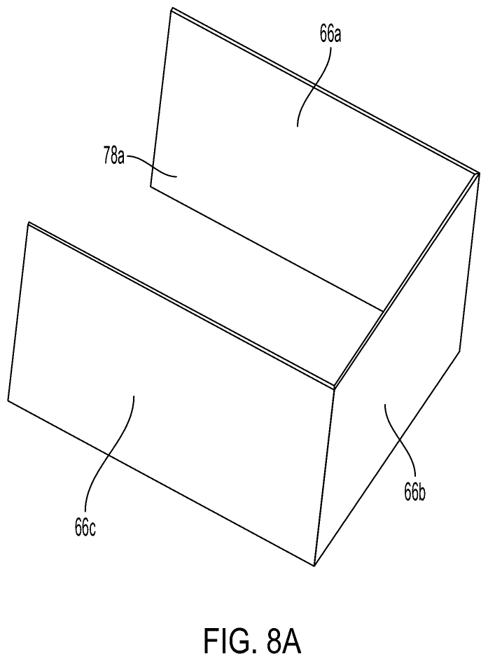

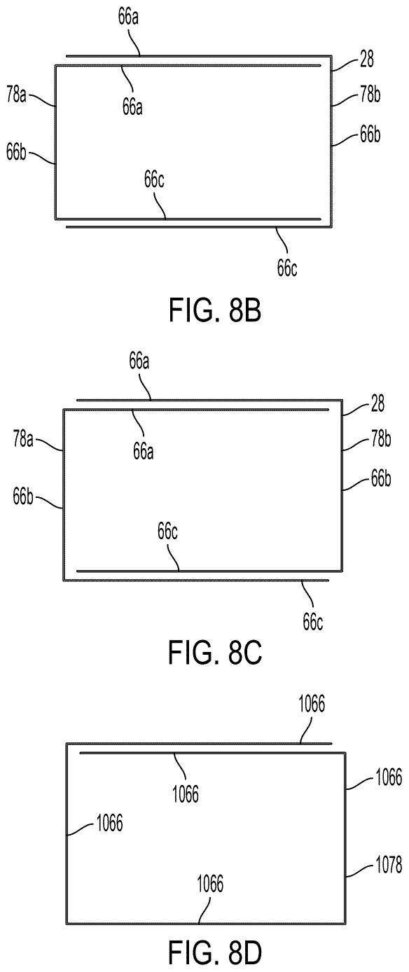

As shown in FIGS. 8-8B, the first or inner structural layer 26 of the food container assembly 10 includes the innermost assembly of structural sidewalls of the container 14. The inner structural layer 26 includes a body 28 including one or more panels 66 that, together, form an inner surface 86 that at least partially encompasses and defines the boundaries of the interior volume 18. In some embodiments, the panels 66 of the inner layer 26 form an overall tubular shape that extends around and defines the side boundaries of the interior volume 18 while being open and providing access to the interior volume 18 on both the top 70 and bottom ends 74 thereof.

In some embodiments, the body 28 defines a body axis 80 passing through the interior volume 18 and a reference plane 84 oriented normal to the body axis 80. In such embodiments, the cross-sectional shape of the perimeter of the body 18 taken along the reference plane 84 is completely enclosed. In still other embodiments, the axis 80 is oriented vertically within the body 28 such that it passes through the open top 70 and bottom 74 of the inner structural layer 26. In still other embodiments, the panels 66 of the inner structural layer 26 may be moved relative to each other to adjust the body 28 between a closed configuration, in which the cross-sectional shape of the perimeter of the body taken along the reference plane 84 is completely enclosed, and an open configuration, in which the cross-sectional shape of the perimeter of the body 28 taken along the reference plane 84 is open in at least one location. In still other embodiments, the body 28 may be adjusted between the open and closed configuration by adding and removing panels 66.

In the illustrated embodiment, the panels 66 of the inner layer 26 are planar and arranged to form a substantially rectangular cross-sectional shape taken along the reference plane 84. While the illustrated panels 66 are rigid, rectangular, and planar, it is understood that in other embodiments the panels 66 may be non-planar (e.g., curved) and form non-rectangular shapes. Furthermore, while the illustrated inner layer 26 forms an inner volume 18 that has a substantially rectangular cross-sectional shape taken along the reference plane 84, it is understood that in other embodiments different cross-sectional shapes such as circle, elliptical, polygonal, and the like may be formed. In still other embodiments, additional panels 66 may be included to enclose one or both of the top and bottom ends 70, 74 of the interior volume 18.

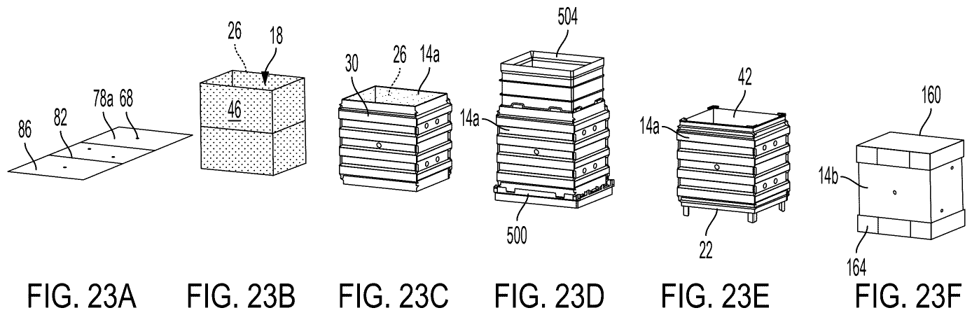

In some embodiments, the panels 66 of the inner layer 26 may also have one or more apertures or sample ports 68 formed therein to allow access to the interior volume 18 through the inner structural layer 26. As shown in FIG. 23F, the ports 68 are included in each of the panels 66a-c with the ports 68 being positioned at different vertical heights (e.g., at different relative positions with respect to the top and bottom ends 70, 74) on each of the different panels 66a-c. In embodiments where panels 66a-c of the inner structural layer 26 overlap, the ports 68 are configured to align so that the ports 68 in the overlapping panels 66a-c provide unobstructed access from outside the container assembly 10 to the interior volume 18. In embodiments where an exterior structural layer 30 is present, the ports 68 included in the exterior structural layer 30 also align with the ports 68 of the interior structural layer 26 so that unobstructed access from outside the container assembly 10 and through both the inner and outer structural layers 26, 30 is provided by the ports 68 (see FIG. 23C).

In some embodiments, the panels 66 of the inner structural layer 26 are joined together to form one or more wall segments 78a, 78b. The segments 78a, 78b are then combined or otherwise coupled together to produce the body 28 of the inner layer 26. In the illustrated embodiment, the inner layer 26 is formed from two segments 78a, 78b, each having three panels 66a-c incorporated therein such that some panels 66 overlap with one another when forming the final inner structural layer 26 (see FIG. 8B). In other embodiments more or fewer segments 78a, 78b may be present with the number of panels 66 incorporated into each segment 78a, 78b varying. For example, in some embodiments a single segment 1078 may be present having six panels 1066 formed therein (see FIG. 8D). In other embodiments four segments 78 each having a single panel 66 may be used. In still other embodiments, a single segment 78 containing four panels 66 may be used. In still other embodiments, additional combinations of segments 78, panels 66, and overlapped panels may be used to assemble the inner structural layer 26 and produce the desired size and shape of the inner volume 18.

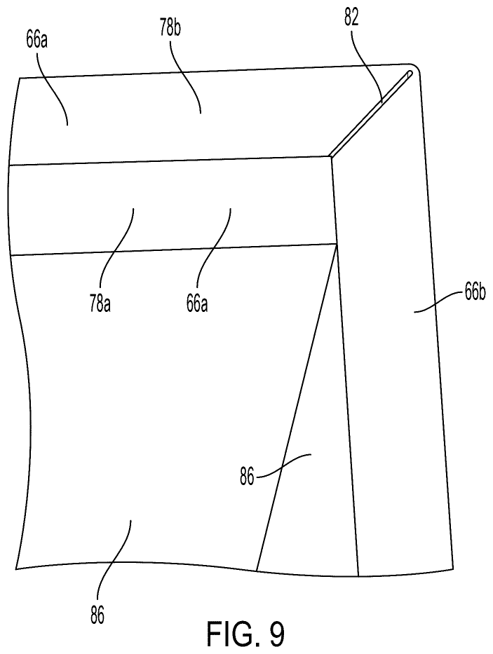

As shown in FIGS. 8-9, each segment 78a, 78b of the inner structural layer 26 is formed from a single piece of sheet material. In some embodiments, each piece of sheet material includes one or more (e.g., two) joints 82 cut or otherwise formed therein to separate and form the individual panels 66a-c. In some embodiments, the joints 82 include a wedge-cut formed into the interior surface 86 of the sheet material to allow that area of the material to serve as a hinge or folding point. The material may then be folded along the joint 82 to form two panels 66 at an angle relative to each other see FIGS. 8A and 9). In the illustrated embodiment, the wedge cut is a 90-degree wedge cut where the resulting cut surfaces are angled approximately 90 degrees from each other. As such, the user can then fold the material along the cut so that, once folded, the resulting interior surfaces 86 are positioned 90 degrees from each other (see FIG. 9). In other embodiments, different angled wedge cuts may be used to allow the interior surfaces 86 to be placed at different angles relative to each other.

While the illustrated segments 78a, 78b are formed from a single piece of sheet material, it is understood that in other embodiments one or more of the segments 78 may be formed from multiple pieces of material joined together to form a single entity. In such embodiments, adjacent panels 66 may be interconnected using some form of joint. The resulting joints 82 may be flexible, rigid, or a combination thereof.

In the illustrated embodiment, the inner structural layer 26 is formed from one or more pieces of a paperboard material. More specifically, each segment 78a, 78b is formed from a single, continuous piece of paperboard material. In some embodiments, the paperboard material includes a non-corrugated paperboard that is approximately ¼″ thick. In other embodiments, the paperboard material may be between ⅛″ and ⅜″ thick. In still other embodiments, the paperboard may be between ⅛″ and 7/16″ thick. In still other embodiments, the paperboard material may be between ⅛″ and ½″ thick. In still other embodiments, the paperboard material may be corrugated. In still other embodiments, the resulting inner structural layer 26 is sufficiently strong to undergo the shipping process with the foodstuff contained in the inner volume 18 but not necessarily strong enough to undergo the forces applied to the inner layer 26 during the manufacturing of the foodstuff. Instill other embodiments, the inner structural layer 26 is formed from Dura-Fibre. In still other embodiments, the inner structural layer 26 may also be formed from chipboard, fiberboard, and/or plastic.

To assemble the inner layer 26, one or more pieces of planar sheet material (e.g., of paperboard material) are obtained. In the illustrated embodiment, each piece of sheet material is configured to forma segment 78a, 78b to be included in the body 28 of the inner layer 26. As shown in FIG. 23A, each piece of sheet material includes one or more joints 82 (e.g., two) cut or otherwise formed therein to correspond with the size and shape of the panels 66a-c included in the finished segments 78a, 78b (see FIG. 23A). In embodiments where sample ports 68 are present, they may be pre-formed or formed into the sheet material.

With the sheet material obtained, the sheet material may then be folded at the joints 82 to produce the segment 78a, 78b shapes. In the illustrated embodiment, the two flanking panels 66a, 66c of both segments 78a, 78b are folded inwardly approximately 90 degrees relative to the central panel 66b to form an overall “U” shape (see FIGS. 8A and 8B).

With the segments 78a, 78b shaped, the first segment 78a is then nested within the second segment 78b such that the three panels 66a-c of the first segment 78a and the central panel 66b of the second segment 78b form the inner surface 86 of the resulting structure (e.g., define the cross-sectional shape of the inner volume 18; see FIG. 8, 8B). The remaining two panels 66a, 66c of the second segment 78b overlap with and are positioned immediately behind the first and third panels 66a, 66c of the first segment 78a, respectively. The two segments 78a, 78b may then be secured together using a strap or other form of connection (e.g., fasteners, adhesive, pins, and the like). The final connection may be permanent or temporary as needed.

While the illustrated body 28 includes the first segment 78a being nested within the second segment 78b (see FIG. 8B), in other embodiments, the first and second segments 78a, 78b may be interlocked using other layouts. For example, as shown in FIG. 8C, the first segment 78a may be interlocked with the second segment 78b such that two panels 66a, 66b of the first segment 78a and two panels 66c, 66b of the second segment 78b form the inner surface 86 of the resulting structure. In such an embodiment, one panel from each segment 78a, 78b overlaps with and is positioned immediately behind the inner panels 66a, 66c of the opposite segment 78a, 78b, respectively (see FIG. 8C). The advantage of such embodiments is that both segments 78a, 78b may have identical geometric shapes whereas the nesting configuration of FIG. 8B requires that the central panels 66b of both segments 78a, 78b to have different widths (e.g., the width of the central panel 66b of the first segment 78a is less than the width of the central panel 66b of the second segment 78b to compensate for the nesting layout). As such, less unique parts need to be manufactured for the layout of FIG. 8C.

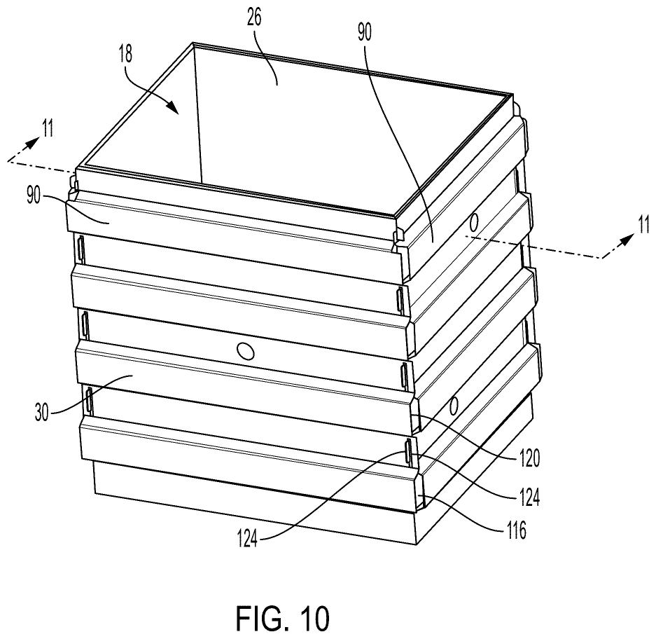

As shown in FIGS. 10-18, the second or outer structural layer 30 of the food container assembly 10 includes an assembly of structural wall panels 90 positioned outside the inner structural layer 26 relative to the inner volume 18. The outer structural layer 30 includes one or more panels 90 that, together, at least partially encompass and strengthen the inner structural layer 26. During use, the outer structural layer 30 serves as reinforcement for the inner layer 26 acting as a rigid girdle that restricts outward expansion and deflection of the inner layer 26. In addition to supplementing the strength of the inner layer 26, the outer layer 30 also serves as a structural member itself being sized and shaped to convey vertical loads between the base 22 and top cap 42 (discussed below). When assembled, the outer layer 30 has a greater overall height (e.g., the distance between the top edge 108 and the bottom edge 112) than the adjacent inner layer 26 so that all vertical forces applied to the cap 42 are transmitted through the outer layer 30 and bypass the inner layer 26.

The outer structural layer 30 includes a plurality of individual panels 90 that are releasably attached to one another to form a loop about the inner layer 26 that is resistant to outward expansion. The panels 90 are further configured so that they can be installed around and removed from the inner layer 26 without impacting the integrity of the interior volume 18 or requiring any foodstuffs contained therein to be removed therefrom. In the illustrated embodiment, the panels 90 of the outer layer 30 are sized and shaped so that each panel 90 corresponds with and is sized to mirror the outer profile of a corresponding outwardly exposed panel 66 of the inner layer 26 (e.g., four panels 90 sized and shaped to correspond with the four outwardly exposed panels 66 of the inner layer 26, see FIG. 10). However, in other embodiments, more or fewer panels 90 may be present in the outer layer 30 as necessary to sufficiently brace the inner layer 26 for any anticipated forces and pressures exerted thereupon during the food manufacturing process.

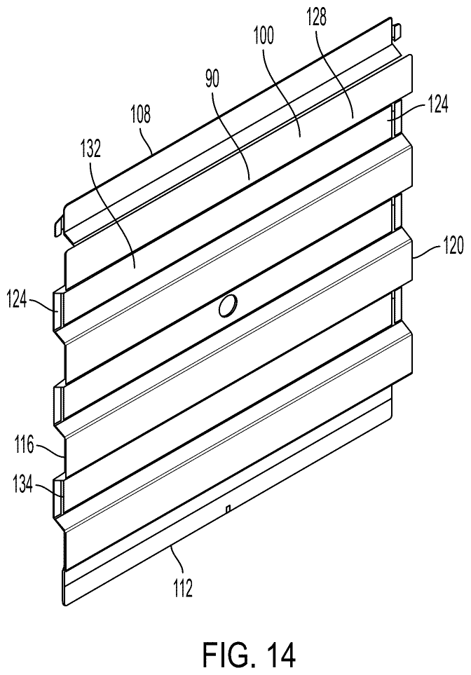

Each panel 90 of the outer structural layer 30 includes a generally sheet-like body 100 formed from a metallic material (e.g., stainless steel) with a top edge 108, a bottom edge 112 opposite the top edge 108, a first side edge 116 extending between the top edge 108 and the bottom edge 112, and a second side edge 120 opposite the first side edge 116 (see FIG. 14). The first and second side edges 116, 120, in turn, form corresponding connection interfaces 124 for releasably coupling to each panel 90 to adjacent panels 90.

The body 100 of each panel 90 is contoured (e.g., non-planar) in order to maximize structural rigidity for the given weight of material used. In the illustrated embodiment, the body 100 includes a series of alternating ribs 128 and valleys 132 extending in a parallel fashion between the first side edge 116 and the second side edge 120 over the entire height of the body 100. The resulting pattern is intended to increase rigidity along the width of the panel itself (e.g., between the first side edge 116 and the second side edge 120). While the illustrated panel 90 relies on integrally formed contours for increased rigidity, it is understood that in alternative embodiments supplemental ribs or other supports may be attached to the body 100 in addition to or in place of the integral contouring for increased strength.

Each connection interface 124 of each panel 90 serves as connection point where a given panel 90 may be releasably attached to an adjacent panel 90. As shown in FIG. 10, the connection interfaces 124 are positioned along the first and second side edges 116, 120 of each panel 90 so that when two panels 90 are joined together they are oriented with their side edges 116, 120 adjacent to one another. As a result, the illustrated connection interfaces 124 allow the assembled panels 90 form a “loop” of panels 90 positioned edge to edge extending 360 degrees around the inner layer 26 (see FIG. 10).

In the illustrated embodiment, the connecting interfaces 124 include corresponding hook 130 and slot 134 connectors (see FIGS. 10, 14, 15, 17 and 18) whereby the hook 130 of one panel 90 may be inserted and locked into the slot 134 of the adjacent panel 90. While the illustrated connection interfaces 124 include hook and slot type connections, it is understood that in other embodiments different forms of connection may also be used such as, but not limited to, pins, fasteners, straps, and the like.

Furthermore, while the illustrated outer structural layer 30 is shown having four separate panels 90, each individually formed and interconnected, it is understood that in other embodiments different combinations and sub-combinations of panels 90 may be present in the final assembly. For example, the outer layer 30 may use segments containing multiple interconnected panels 90 to limit the overall number of loose parts. In still other embodiments, two or more of the panels 90 may be formed together as a single piece to limit the number of connections that need to be made.

To install the outer layer 30 on a pre-existing inner layer 26, the user first positions a panel 90 of the outer layer 30 adjacent to a corresponding panel 66 of the inner layer 26. In the illustrated embodiment, the user may do so by placing the body 100 of one or more of the panels 90 in contact with the corresponding outer surface of the panel 66 to which it is paired. After doing so, the user may then align and releasably connect adjacent panels 90 together by inserting each hook 130 into a corresponding slot 134 of an adjacent panel 90 and locking it in place (e.g., by sliding one panel 90 vertically relative to the other). While the illustrated outer layer 30 is shown in direct contact with the inner layer 26, it is understood that in some embodiments liners, padding, barriers, heating elements, refrigerating elements, and the like may be positioned between the inner and outer layers 26, 30.

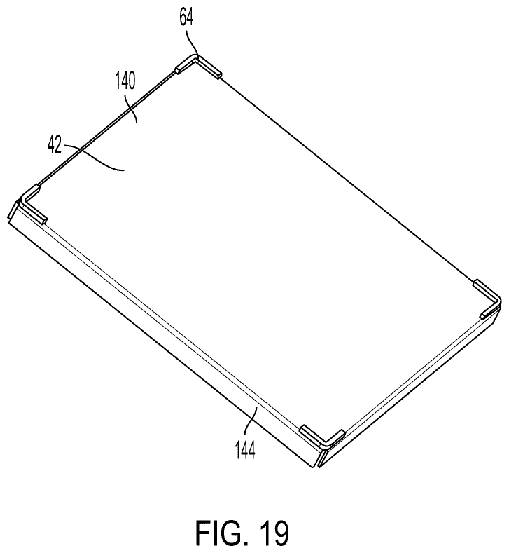

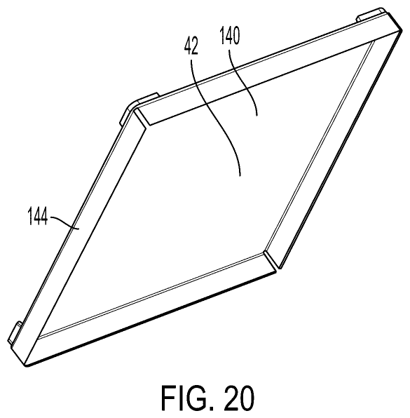

As shown in FIGS. 19 and 20, the top cap 42 of the container assembly 10 is configured to selectively enclose the top 70 of the interior volume 18 when the container 14a is in the first configuration. More specifically, the top cap 42 includes a panel 140 sized and shaped to correspond with the size and shape of outer layer 30. The top cap 42 also includes a sidewall 144 that is configured to encompass the top edge 108 of the panels 90 of the outer layer 30.

The top cap 42 also includes a plurality of stacking lips 64 extending therefrom opposite the sidewall 144. Together, the stacking lips 64 are sized, shaped, and positioned to interact with the legs 54 of the base 22 to help maintain the relative position between the current container 14 and any containers 14 stacked thereon. In the illustrated embodiment, the stacking lips 64 are substantially “L” shaped and positioned at the far corners of the cap 42 so that the legs 54 of a corresponding container 14 will nest within the lips 64.

When installed on a container 14a in the first configuration, the panel 140 and sidewall 144 of the top cap 42 is sized so that the top edge 108 of the panels 90 of the outer layer 30 rest on the underside of the panel 140. As such, any weight placed on the cap 42 (e.g., a stacked container 14 or other implement) is transmitted into the outer layer 30 instead of the inner layer 26.

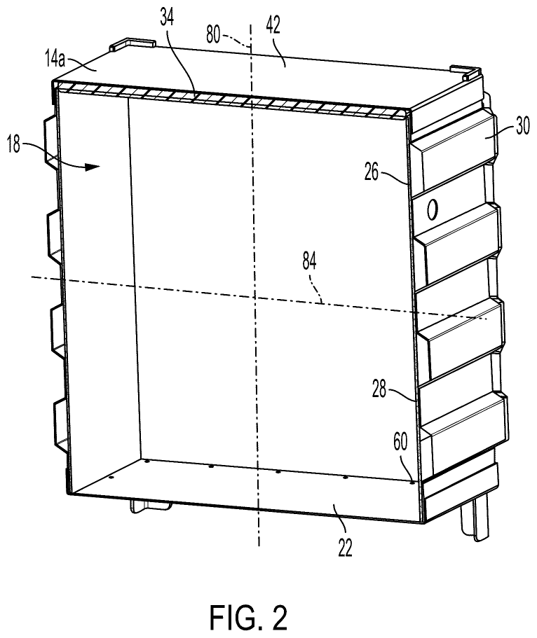

As shown in FIG. 2, the press assembly 34 of the container assembly 10 is configured to be placed within the interior volume 18 between the foodstuff and top cap 42. During the food manufacturing process, the press assembly 34 provides a downward pressure onto the top surface of the foodstuff (e.g., the forming cheese block) to help knit the foodstuff into a solid block. In the illustrated embodiment the press assembly 34 includes a press board 150 and a biasing member (not shown) positioned between the board 150 and the cap 42 such that the biasing member biases the board 150 away from the cap 42 and downwardly into engagement with the foodstuff contained in the volume 18. While a spring-loaded board 150 is used in the current embodiment, it is understood that other forms of press assembly 34 may be used.

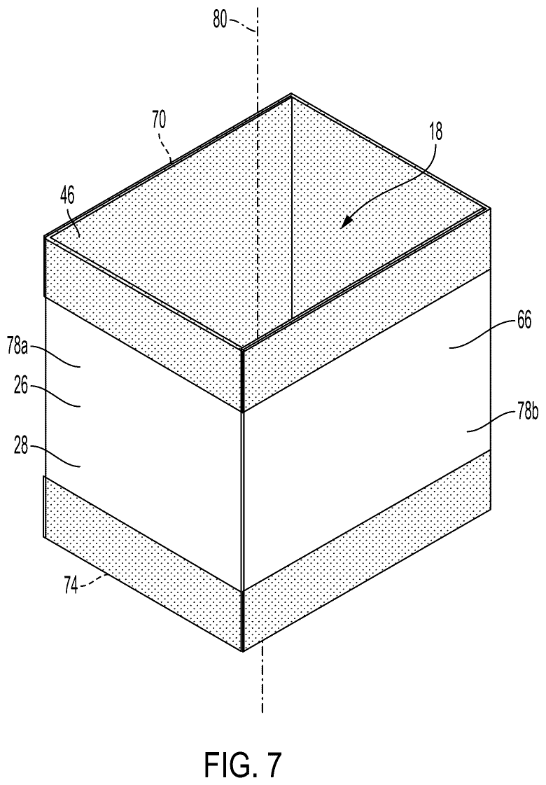

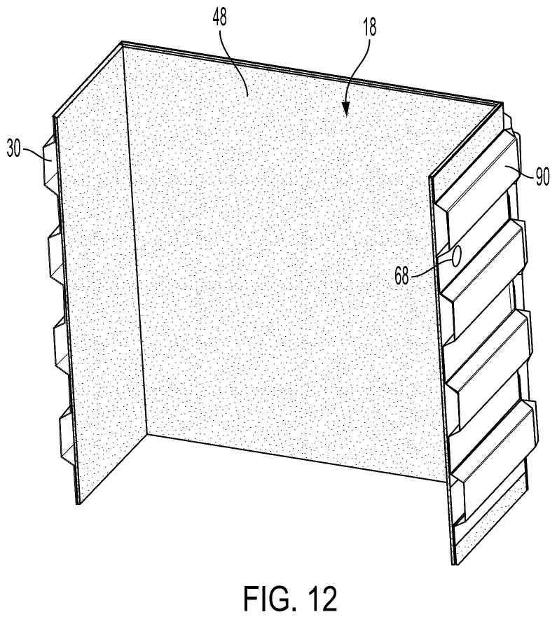

As shown in FIGS. 7 and 12, the container assembly 10 may include an inner liner 46 and an outer liner 48 to help protect and contain the foodstuff in the interior volume 18. In the illustrated embodiment, each liner 46, 48 is a substantially cylindrical sleeve of plastic or other polymer materials that is generally waterproof and positioned so that it serves as a barrier between the foodstuff and the inner layer 26. The specific makeup and characteristics of the liners 46, 48 may be adjusted as needed to accommodate the specific foodstuff being made.

While in the manufacturing configuration, the container 14a consists of at least the inner structural layer 26 and the outer structural layer 30. More specifically, the illustrated container 14a includes the base 22, the inner structural layer 26, the outer structural layer 30, the top cap 42, and the press assembly 34. In still further embodiments, the container 14a may also include a first or inner liner 46 and a second or outer liner 48. As indicated above, the combination of the inner and outer structural layers 26, 30 results in a container 14a having increased sidewall strength and rigidity that is able to withstand the greater forces and pressures present during the food manufacturing process.

To assemble the container 14 in the manufacturing configuration, the user first assembles the inner structural layer 26, as described above, securing the two segments 78a, 78b together using a strap or other form of fastening (see FIG. 8). Once assembled, the user may then install the first or inner liner 46. To do so, the user inserts the liner in the inner volume 18 of the inner layer 26 and folds the ends of the liner over both the top and bottom ends 70, 74 of the inner layer 26 (see FIG. 7).

With the first liner 46 in place, the user may then apply the outer structural layer 30 to the inner structural layer 26. To do so, the user first positions each panel 90 of the outer layer 30 adjacent to a corresponding panel 66 of the inner layer 26. After doing so, the user may then align and releasably connect adjacent panels 90 of the outer layer 30 together by inserting each hook 130 into a corresponding slot 134 of an adjacent panel 90 and locking it in place (e.g., by sliding one panel 90 vertically relative to the other). Once complete, the outer layer 30 has entered an “installed position” in which the outer structural layer 30 provides structural support for and encompasses the inner structural layer 26 (see FIG. 10).

With the outer layer 30 in place, the user may then apply the second or outer liner 48. To do so, the user inserts the liner 48 in the inner volume 18 and then folds the ends of the liner over the top and bottom edges 108, 112 of the panels 90 of the outer layer 30 (see FIG. 12). By doing so, the container 14a now includes two layers of liner material 46, 48 along the inner surface 86 of the inner layer 26.

With both layers 26, 30 and both liners 46, 48 in place, the user may then position the resulting assembly on the platform 50 of the base 22. When doing so, the user aligns and positions the elements so that the bottom edges 112 of each panel 90 of the outer layer 30 are positioned inside the exterior wall 58 of the platform. By doing so, the exterior wall 58 of the base 22 helps encompass and support the bottom edges 112 of both the exterior panels 90 and the inner panels 66.

With both layers 26, 30 and both liners 46, 48 positioned on the base 22, the top 70 of the interior volume 18 remains open to allow the container 14a to be filled with the initial ingredients and inputs of the foodstuff to be made. This is the fill configuration. Once the volume 18 is filled and after any initial processing steps to the foodstuff is completed, the second liner 48 may be closed at the top end 70 and the press assembly 34 placed atop the foodstuff within the interior volume 18. Finally, the top cap 42 may be added to complete the assembly (see FIGS. 1 and 2).

When in the shipping configuration, the container 14b does not include the outer layer 30 and only consists of the inner layer 26. More specifically, the illustrated container 14b includes the inner structural layer 26, a top travel cap 160, and a bottom travel cap 164.

Both the top travel cap 160 and the bottom travel cap 164 are formed from the same material as the panels 66 of the inner layer 26 (e.g., paperboard, see above). In the illustrated embodiment, the top travel cap 160 and the bottom travel cap 164 are both configured to selectively enclose the top 70 and bottom 74 of the inner layer 26 when the container 14b is in the second configuration. More specifically, the top travel cap 160 includes a panel 168 sized and shaped to correspond with the size and shape of the top 70 of the inner layer 30 while the bottom travel cap 164 includes a panel 172 that is sized and shaped to correspond with the size and shape of the bottom 74 of the inner layer 26. Both the top travel cap 160 and bottom travel cap 164 also include a sidewall 174, 178, respectively, that is configured to encompass the top 70 and the bottom 74 of the panels 66 of the inner layer 26, respectively. By doing so, the top and bottom travel caps 160, 164 help maintain the structural integrity of the body 28 of the inner layer 26 by helping to hold the two segments 78a, 78b in place.

With the top travel cap 160, bottom travel cap 164, and inner layer 26 combined, the resulting structure is relatively light weight and formed of materials considered one-time-use or disposable (e.g., paperboard and the material of the liners 46, 48). As such, after the user receives the shipped foodstuff, the user can remove the product from the container 14b and dispose of the remaining container 14b remnants without having to return any elements to the original manufacturer—saving cost.

To re-configure the container from the first configuration 14a to the second configuration 14b, the user removes the top cap 42, press assembly 34, and outer structural layer 30 therefrom (e.g., placing the outer structural layer 30 in a “detached position” where it does not support or encompass the internal structural layer 26). When doing so, the layout and design of these elements is such that the foodstuff within the interior volume 18 does not need to be removed from the interior volume 18 during the process. Furthermore, both liners 46, 48 remain intact and undamaged.

Once removed, the user may then fold and package the top ends of both the first and second liners 46, 48 and seal the top 70 with a top travel cap 160. As discussed above, the top travel cap 160 is formed from the same material as the inner structural layer 26.

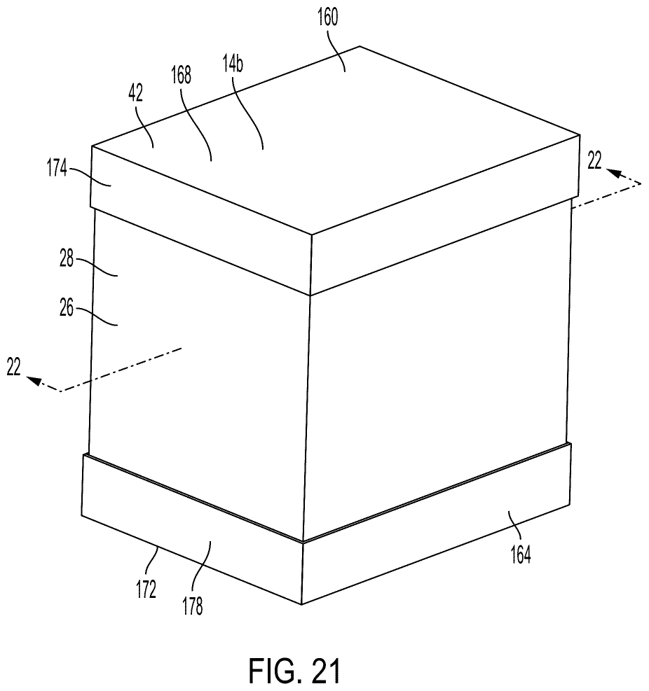

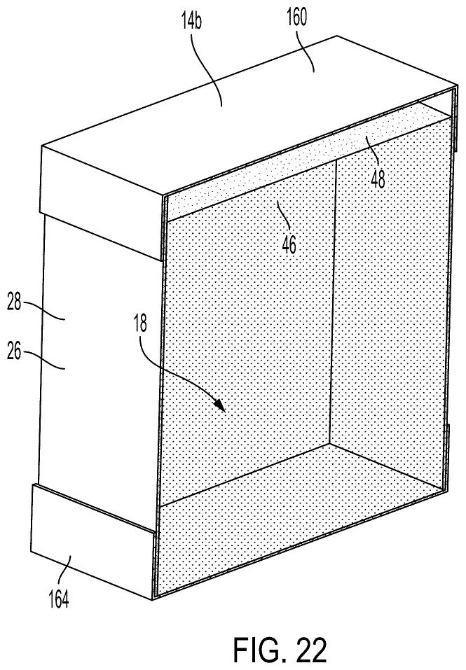

With the top 70 completed, the user may then remove the assembly from the base 22 and complete the packing of the bottom 74 by folding and packing both liners 46, 48 and sealing the bottom 74 with the bottom travel cap 164 (see FIGS. 21 and 22). With all of the elements in place, the user may then secure everything in place using bands or other fasteners and ship the completed product to an end user.

To manufacture a 640-pound cheese block using a first manufacturing process, the user first begins by obtaining one or more pieces of sheet material (e.g., paperboard; see FIG. 23A). The sheet material may then be folded and assembled to produce the body 28 of the inner layer 26 as described above. Once the body 28 is assembled, the user may then install the first or inner liner 46 therein. To do so, the user inserts the liner 46 in the inner volume 18 of the inner layer 26 and folds the ends of the liner over both the top and bottom ends 70, 74 of the inner layer 26 (see FIG. 23B).

With the inner layer 26 and liner 46 in place, the outer structural layer 30 is then applied to the exterior of the inner layer 26 as described above (see FIG. 23C). In some embodiments, the second liner 48 may also be installed after the outer layer 30 is in place.

In some embodiments, the resulting combination of the inner and outer layers 26, 30 may then be placed on a base pan 500 (e.g., where the bottom edges 112 are inserted into the base pan 500; see FIG. 23D). A funnel 504 is also placed on top of the combined inner and outer layer 26, 30 (e.g., where the top edges 108 are inserted into the bottom of the funnel 504). As such, the interior volume 18 is accessible via the funnel 504.

With the interior volume 18 open, the user then fills the volume 18 of the container 14a via the funnel 504 with the necessary ingredients to begin the cheesemaking process. The cheese is then processed (e.g., whey extraction, pressing, tipping, and vacuuming).

With the initial processing complete, the container 14a is then closed for aging. To do so, the funnel 504 is removed from the container 14a exposing the top 70 of the volume 18. Once exposed, the inner and outer liners 46, 48 are folded. After the liners 46, 48 are folded, the base 22 is installed and the entire container 14a and base 22 assembly rotated 180 degrees (e.g., so that the base 22 is now at the bottom and the base pan 500 is now at the top). The base pan 500 may then be removed to expose the bottom 74 of the volume 18 so that the exposed ends of the inner and outer liner 46, 48 may be folded. Finally, the press assembly 34 and top cap 42 are installed and the resulting container 14a placed in storage for aging (see FIG. 23E).

With the volume 18 sealed, the container 14a and processed cheese then remain in cold aging for approximately 10 days. During this time, whey and other liquids are allowed to drain through the bottom of the container 14a via the apertures 60 in the base 22. At the same time, the press assembly 34 continues to apply a compressive force against the curing cheese within the volume 18 to help knit the cheese into a solid block.

After the aging process is complete, the user then takes the container 14 with the finished cheese block therein and coverts the container to the shipping configuration 14b for final shipment to the end consumer. To do so, the user removes, among other things, the outer structural layer 30, the press assembly 34, the top cap 42, and the base 22 (described above). The user executes these steps without having to remove the cheese block from the volume 18 or having to transfer the cheese block into a new container.

After the above-listed elements are removed, the user then seals both sides of both liners 46, 48, and applies travel caps 160, 164 to the top and bottom 70, 74 of the body 28 of the inner structural layer 26. The resulting assembly is a completed 640-pound cheese block within a container 14b that, in turn, contains panels only formed from paperboard or other disposable materials. After the end user receives the cheese block, the user may discard the container 14b.

Meanwhile, the elements removed from the container 14 after the food manufacturing process was complete (e.g., the outer structural layer 30, the press assembly 34, the base 22, and the top cap 42) all remain at the manufacturer's facility and may be re-used in subsequent runs where only the inner structural layer 26, liners 46, 48, and travel caps 160, 164 need be replaced.

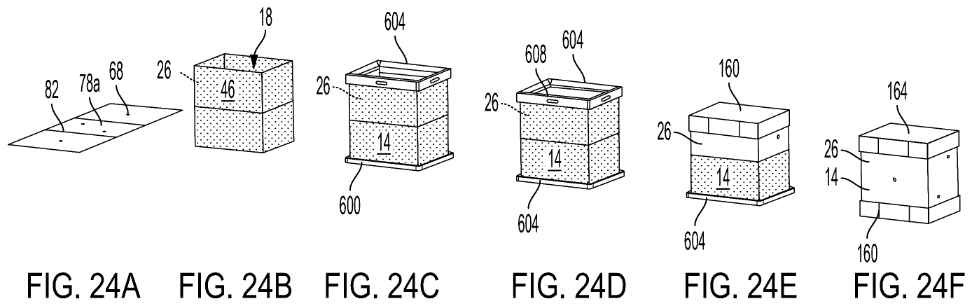

To ship a pre-made 640-pound cheese block 608 using a second manufacturing process, the user first begins by obtaining one or more pieces of sheet material (e.g., paperboard; see FIG. 24A). The sheet material may then be folded and assembled to produce the body 28 of the inner layer 26 as described above. Once the inner layer 26 is assembled, the user may then install the first or inner liner 46 therein. To do so, the user inserts the liner 46 in the inner volume 18 of the inner layer 26 and folds the ends of the liner over both the top and bottom ends 70, 74 of the inner layer 26 (see FIG. 24B).

The resulting combination of the inner layer 26 and liner 46 may then be placed on a base pan 600 (e.g., where the bottom end 74 is inserted into the base pan 600; see FIG. 24C). A funnel 604 is also placed on top of the inner layer 24 (e.g., where the top 70 is inserted into the bottom of the funnel 604). As such, the interior volume 18 is accessible via the funnel 604.

With the funnel 604 in place, the user then lowers the solid 640-pound block of cheese or collated block 608 into the assembled container 14 via the funnel 604 (see FIG. 24D). Once in place, the funnel 604 is removed exposing the top 70 of the volume 18. The liner 46 may then be folded and sealed, and an end cap 160 installed (see FIG. 24E). Once the end cap 160 is in place, the container 14 is rotated 180 degrees (e.g., so that the end cap 160 is on the bottom and the base pan 600 is on the top; see FIG. 24E).

With the container 14 rotated, the bottom 74 of the volume 18 is exposed. The remaining end of the liner 46 may then be folded and sealed and the second end cap 164 installed. The container 14 may then be bound (e.g., banded) and is ready for shipping as discussed above.

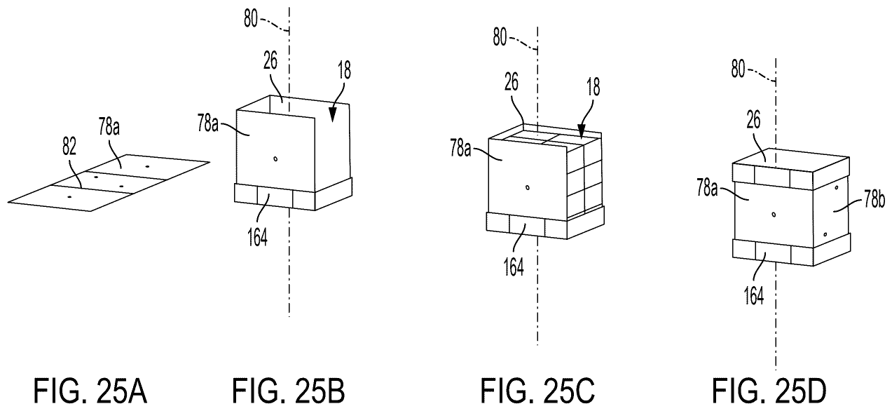

To ship cheese blocks using a third manufacturing process, the user first begins by obtaining one or more pieces of sheet material (e.g., paperboard; see FIG. 25A). The sheet material may then be folded to produce the desired segment shapes 78a, 78b. The first segment 78a is then placed in a first end cap 164 (see FIG. 25B). By doing so, the inner layer 26 is in the open configuration (discussed above) such that the perimeter of the inner layer 26 taken along a reference plane 84 oriented normal to axis 80 oriented vertically within the volume 18 (e.g., passing through the top and bottom ends 70, 74) is open in at least one location.

With the first segment 78a in place and the body 28 in an open configuration, one or more pre-packaged cheese or other foodstuff blocks are placed within the volume 18 (see FIG. 25C). Once the loading is complete, the second segment 78b may be positioned within the first end cap 164 to transition the inner layer 26 to a closed position (discussed above). A second end cap 160 is then added to completely enclose the volume 18. The container 14 may then be bound (e.g., banded) for final shipping.

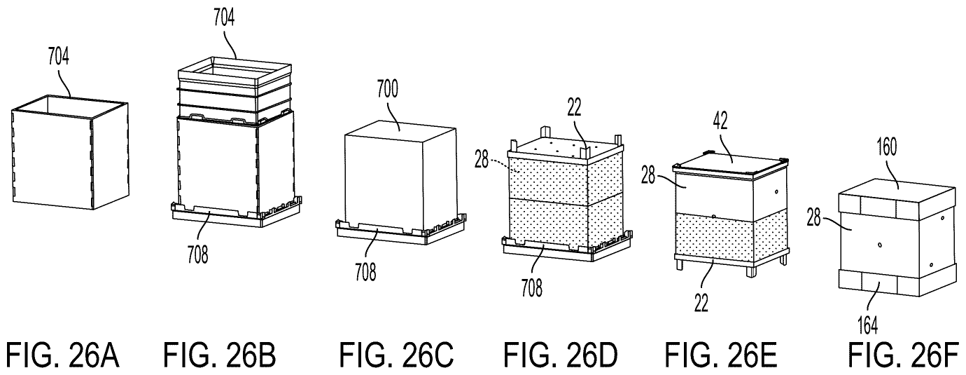

To manufacture a 640-pound cheese block using a fourth manufacturing process, the cheese block 700 is first manufacturing using a separate process shell 704. Within the process shell 704, the block is prepared and aged (see FIGS. 26A and 26B). After the preparation and aging processes are complete, the process shell 704 is removed such that the completed block of cheese 700 remains resting on a base pan 708 (see FIG. 26C).

To prepare the cheese 700 for shipping, the liner 46 and body 28 of the first layer 26 are then applied to the block 700 as it remains resting in the pan 708. To do so, in some embodiments the liner 46 and individual segments 78a, 78b may be folded around the block 700 in situ. In such embodiments, the liner 46 is first applied to the block 700. With the liner 46 in place, the sheet material forming the segments 78a, 78b may then be placed adjacent the block 700 and the individual panels 66a, 66c folded about the block 700 so that the resulting segments 78a, 78b encompass the block along the sides thereof (see FIG. 26D) while allowing the top and bottom ends 70, 74 to remain open. In other embodiments, a fully assembled body 28 (discussed above) may be slide over the block 700 as a single unit.

Once the body 28 and liner 46 are in place, the top 70 of the volume 18 may be closed by folding the liner 46 and installing the base 22 thereon (see FIG. 26D), The resulting structure may then be rotated 180 degrees (e.g., so the base 22 is on the bottom and the base pan 708 is on top; see FIG. 26E). Once rotated, the base pan 708 is removed, the liner folded and sealed, and a top cap 42 installed (see FIG. 26E). The assembly may remain stored in this condition until final shipment is ready to commence, at which time the base 22 and top cap 42 may be replaced by top and bottom shipping caps 160, 164 formed from paperboard (see FIG. 26F). The final assembly may then be banded and shipped.

In other embodiments where the cheese 700 is ready for immediate shipping, the stages of FIGS. 26D and 26E may be omitted. Specifically, instead of applying the base 22 and cap 42 on the body 28, the top and bottom shipping caps 160, 164 may be installed.

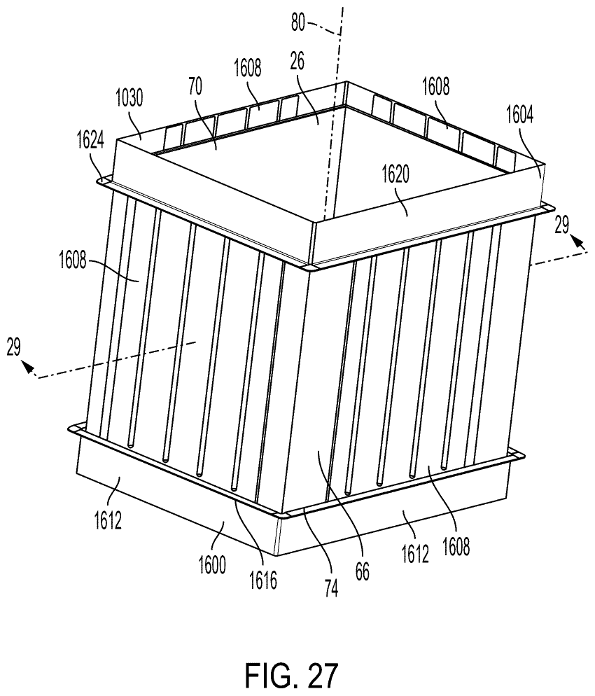

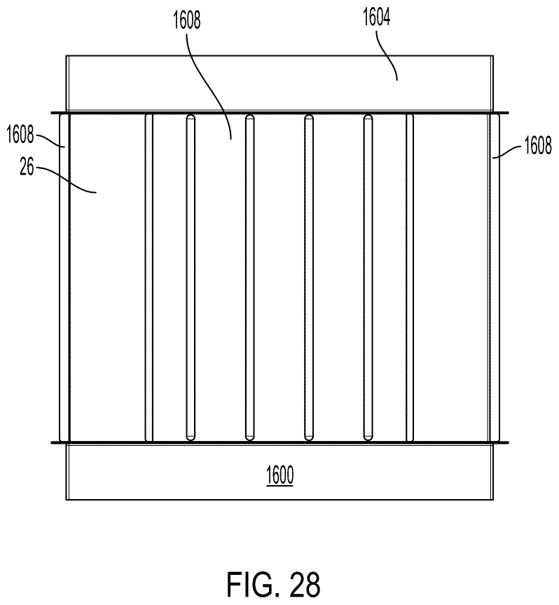

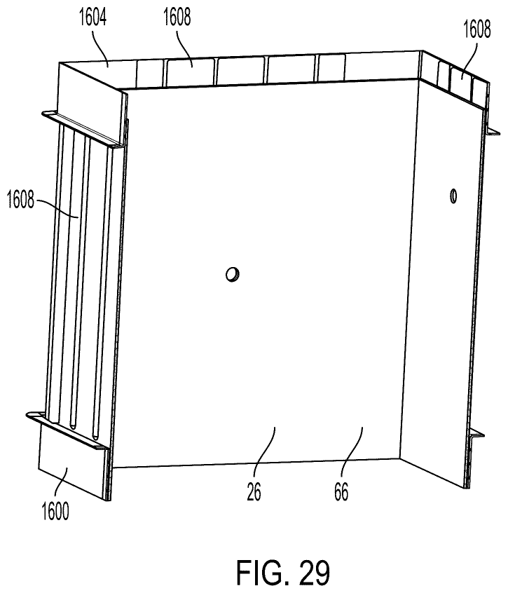

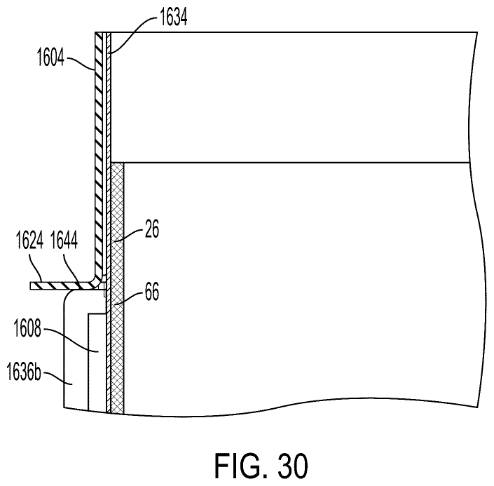

FIGS. 27-32 illustrate another embodiment of the outer layer 1030. The outer layer 1030 is substantially similar to the outer layer 30 as illustrated in FIGS. 10-18 so only the differences will be discussed in detail herein. The outer layer 1030 includes a first or lower band 1600, a second or upper band 1604, and a plurality of panels 1608 extending between and supported by the first band 1600 and the second band 1604. Together, the first band 1600, the second band 1604, and the plurality of panels 1608 serve as reinforcement for the inner layer 26 acting as a rigid girdle that restricts outward expansion and deflection of the inner layer 26.

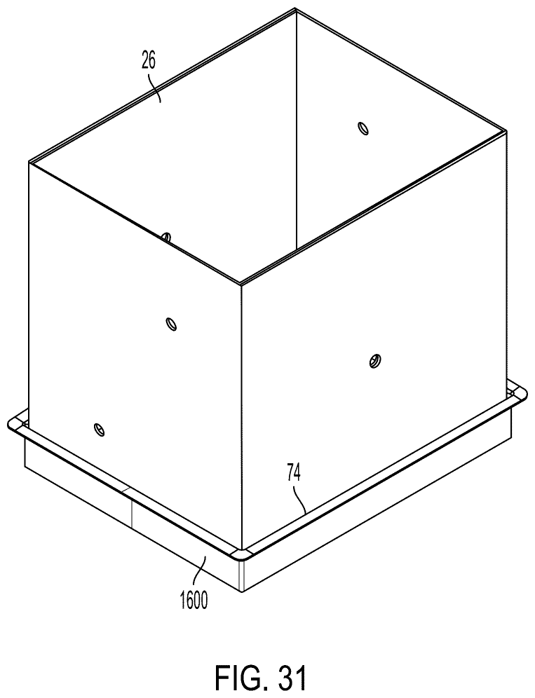

As shown in FIGS. 27 and 31, the first or lower band 1600 of the outer layer 1030 forms an enclosed loop completely encompassing the exterior of the inner structural layer 26. In some embodiments, the first band 1600 is positioned proximate to and encompasses the bottom end 74 of the inner structural layer 26 being oriented generally normal to the body axis 80. In still other embodiments, the first band 1600 has an interior cross-sectional shape that mirrors the cross-sectional shape of the inner structural layer 26 at that same location (e.g., proximate the bottom end 74) being sufficiently large so that at least a portion of a corresponding panel 1608 may be captured between the first band 1600 and the exterior surface of the panels 66 of the inner structural layer 26. In the illustrated embodiment, the first band 1600 has a rectangular inner cross-sectional shape and includes a plurality of segments 1612 (e.g., four), each corresponding with a respective panel 66 of the inner structural layer 26.

The segments 1612 of the first band 1600 may include one or more ribs 1616 extending outwardly therefrom to reinforce the first band 1600 and resist any outward expansion. In the illustrated embodiment, the first band 1600 includes a rib 1616 extending perpendicularly from the upper edge of the segment 1612 (e.g., perpendicular to the body axis 80). However, in other embodiments more or fewer ribs 1616 may be present having the same or different geometric shapes.

As shown in FIG. 27, the second or upper band 1604 of the outer layer 1030 forms an enclosed loop completely encompassing the exterior of the inner structural layer 26 at a location offset (e.g., offset axially relative to the axis 80) from the location where the first band 1600 encompasses the exterior of the inner structural layer 26 to form a gap therebetween. In some embodiments, the second band 1604 is positioned proximate to and encompasses the top end 70 of the inner structural layer 26 being oriented generally normal to the body axis 80. In still other embodiments, the second band 1604 has an interior cross-sectional shape that mirrors the cross-sectional shape of the inner structural layer 26 at that same location (e.g., proximate the top end 70) being sufficiently large so that at least a portion of a corresponding panel 1608 may be captured between the second band 1604 and the exterior surface of the panels 66 of the inner structural layer 26. In the illustrated embodiment, the second band 1604 has a rectangular inner cross-sectional shape and includes a plurality of segments 1620 (e.g., four), each corresponding with a respective panel 66 of the inner structural layer 26.

The segments 1620 of the second band 1604 may include one or more ribs 1624 extending outwardly therefrom to reinforce the second band 1604 and resist any outward expansion. In the illustrated embodiment, the second band 1604 includes a rib 1624 extending perpendicularly from the upper edge of the segment 1620 (e.g., perpendicular to the body axis 80). However, in other embodiments more or fewer ribs 1624 may be present having the same or different geometric shapes.

While the illustrated bands 1600, 1604 are both illustrated as being formed as a single non-disassembled piece (e.g., formed from one or more pieces of material that are fused or otherwise permanently coupled together), it is understood that in other embodiments one or both bands 1600, 1604 may be formed from two or more detachable sub-segments (not shown). In such embodiments, the sub-segments may be configured so that the bands 1600, 1604 may be assembled about the perimeter of the inner structural layer 26. For example, the bands 1600, 1604 may include two “halves” that can clamshell about the exterior of the inner structural layer 26.

Each panel 1608 of the outer structural layer 1030 includes a generally plate-like body 1628 forming a first or bottom edge 1632, and a second or top edge 1634 opposite the bottom edge 1632. During use, when the outer structural layer 1030 is installed immediately outside a pre-existing inner structural layer 26, the panels 1608 are positioned such that they extend between and engage both the first and second bands 1600 (e.g., the first end 1632 engages the first band 1600 while the second end 1634 engages the second band 1604) to transmit forces therebetween. In some embodiments, the engagement between the panels 1608 and the bands 1600, 1604 is such that any outward forces exerted upon the plates 1608 (e.g., forces exerted radially outwardly relative to the axis 80) are transmitted to the bands 1600, 1604 whose shape restricts any outward movement of the panel 1608 itself.

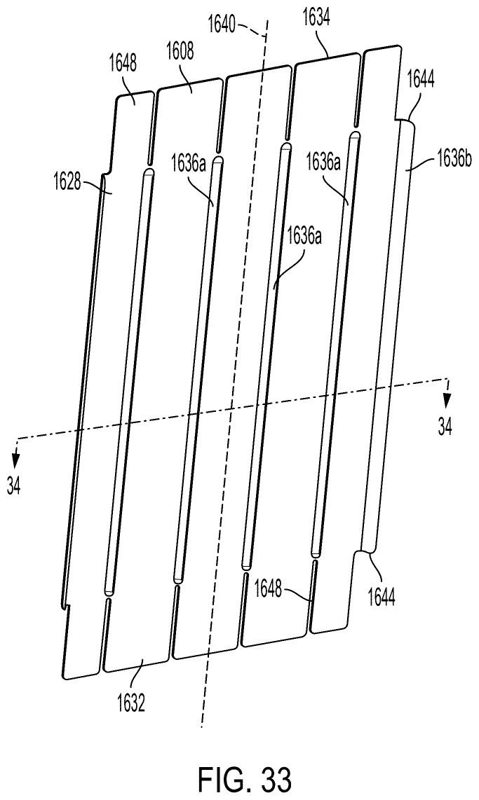

As shown in FIG. 33, each panel 1608 of the outer structural layer 1030 includes one or more ribs 1636 extending generally between the first edge 1632 and the second edge 1634 to provide rigidity along the primary axis 1640 of the panel 1608. In the illustrated embodiments, each panel 1608 includes a plurality of interior ribs 1636a (e.g., 4) spaced equally about the width of the panel 1608, and a pair of exterior ribs 1636b formed into the sides of the panels 1608. In some embodiments, the edges 1644 of the exterior ribs 1636b are configured to engage and rest against the bands 1600, 1604 so that forces can be transmitted therebetween.

Each panel 1608 also includes one or more slots 1648 formed into at least of one of the first end 1632 and the second end 1634. During use, the slots 1648 are configured to allow the ends 1632, 1634 of the panels 1608 to flex and adapt to the contour of the space between the bands 1600, 1604 and the exterior of the inner structural layer 26. In the illustrated embodiment, each slot 1648 is aligned with a corresponding rib 1636 of the panel 1608.

To apply the outer structural layer 1030 to a pre-existing inner structural layer 26 (as discussed above), the first band 1600 is first positioned proximate the bottom end 74 of the inner structural layer 26 (see FIG. 31).

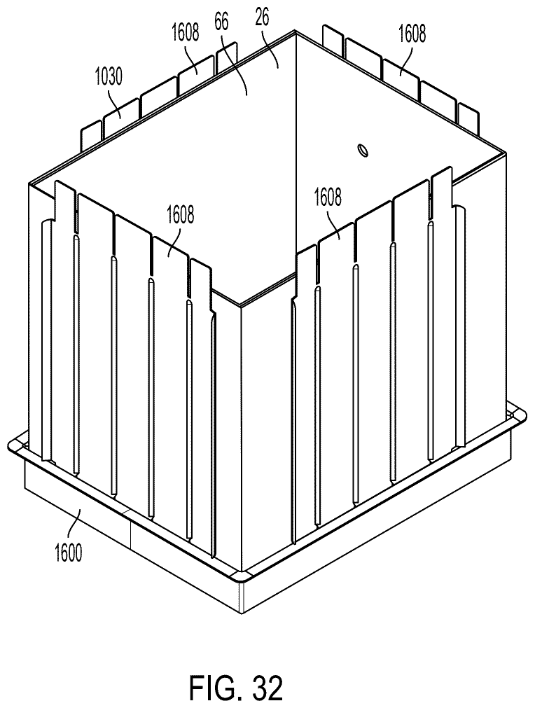

With the first band 1600 in place, the panels 1608 may then be installed. To do so, the first ends 1632 of each panel 1608 are inserted in the space between the first band 1600 and the exterior surface of the inner structural layer 26. Specifically, the first end 1632 is inserted until the edges 1644 of the exterior ribs 1636b contact and rest against the first band 1600 (see FIG. 32). In the illustrated embodiment, one panel 1608 is installed to support each panel 66 of the inner structural layer 26.

After the panels 1608 are positioned, the second band 1604 is introduced over the top 70 of the inner structural layer 26 and slide downwardly (e.g., toward the bottom end 74) until the second ends 1634 of the panels 1608 are captured between the band 1604 and the exterior of the inner structural layer 26 (see FIG. 27). Once captured, the outer structural layer 1030 provides structural support to the inner structural layer 26 as discussed above. In the illustrated embodiment, the second band 1604 is introduced over the top 70 of the inner structural layer 26 until the band 1604 rests atop the edges 1644 of the exterior ribs 1636b of the panel 1608.

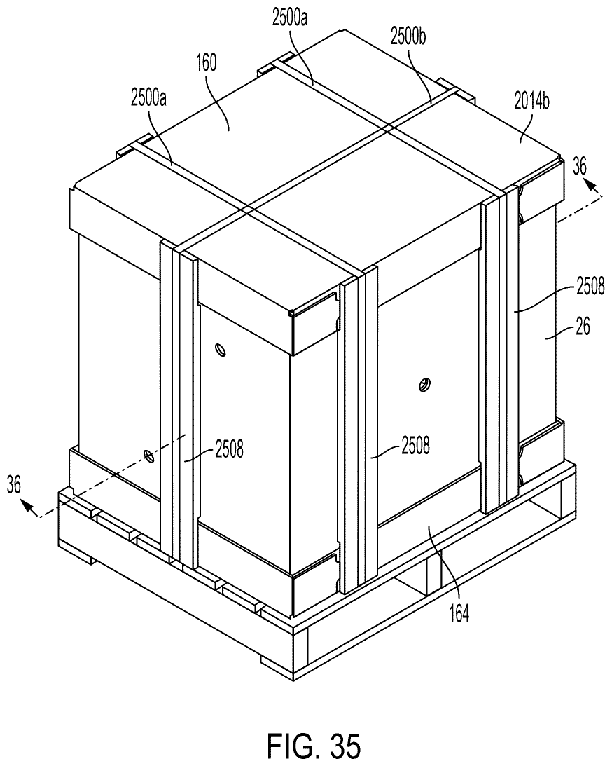

FIGS. 35-37 illustrate another embodiment of the shipping configuration of the container 2014b. The shipping configuration of the container 2014b is substantially similar to shipping configuration of the container 14 discussed above and therefore only the differences will be described in detail herein. The shipping configuration of the container 2014b includes a plurality of straps 2500 extending around the combined exterior of the inner structural layer 26, the top travel cap 160, and the bottom travel cap 164. More specifically, the container 2014b includes at least one lateral strap 2500a extending about the width of the container 2014b and at least one longitudinal strap 2500b extending about the length of the container 2014b. In the illustrated embodiment, the container 2014b includes two lateral straps 2500a positioned equally along the length of the container 2014b and one longitudinal strap 2500b positioned at the center of the width of the container 2014b. While the illustrated straps 2500 only encompass the inner structural layer 26, the top travel cap 160, and the bottom travel cap 164, it is understood that in other embodiments other elements may be encompassed by the straps 2500 along with the container 2014b. For example, the straps 2500 may also encompass a pallet 2504 and the like.

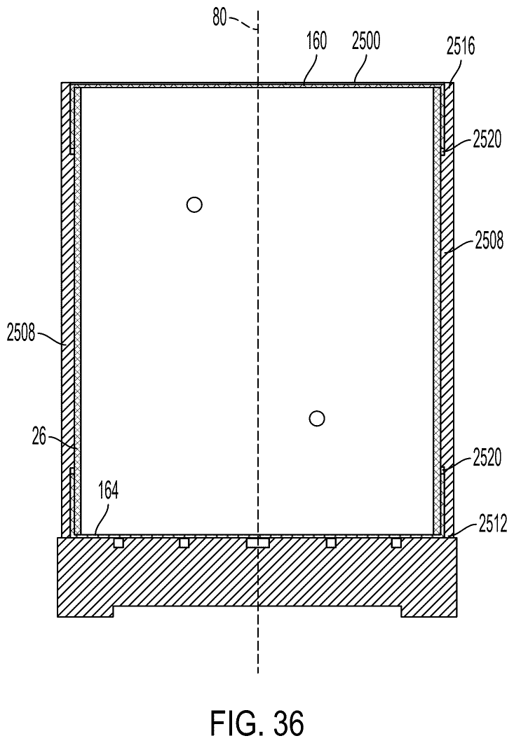

The container 2014b also includes a plurality of external supports 2508. Each support 2508 is substantially elongated and shape forming a first end 2512 and a second end 2516 opposite the first end 2512. As shown in FIG. 36, each support 2508 defines an overall longitudinal length that is substantially equal to the axial distance between the bottom of the bottom travel cap 164 and the top of the top travel cap 160 (e.g., the overall axial height of the container 2014b). Each support 2508 also includes a relief 2520 formed into each end 2512, 2516 to provide clearance for the bottom travel cap 164 and the top travel cap 160.

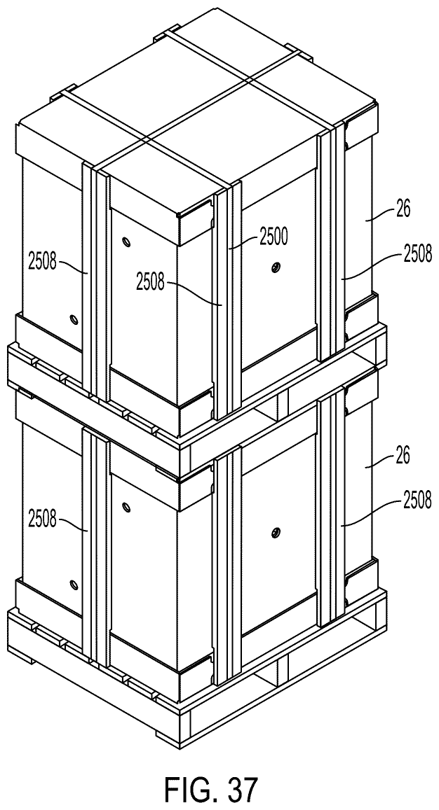

During use, the supports 2508 are configured to provide additional rigidity to the container 2014b when in the shipping configuration in addition to serving as support for any containers that may be stacked thereon (see FIG. 37). When stacked, the supports 2508 are configured to align with each other such that they convey any forces (e.g., such as the weight of the upper containers) to the ground so that they are not borne by the container 2014b itself (e.g., not borne by the inner structural layer 26). In the illustrated embodiment, each support 2508 is aligned with a corresponding strap 2500 such that the straps 2500 secure the supports 2508 to the exterior of the inner structural layer 26. In still other embodiments, each support 2508 is arranged parallel to the axis 80.

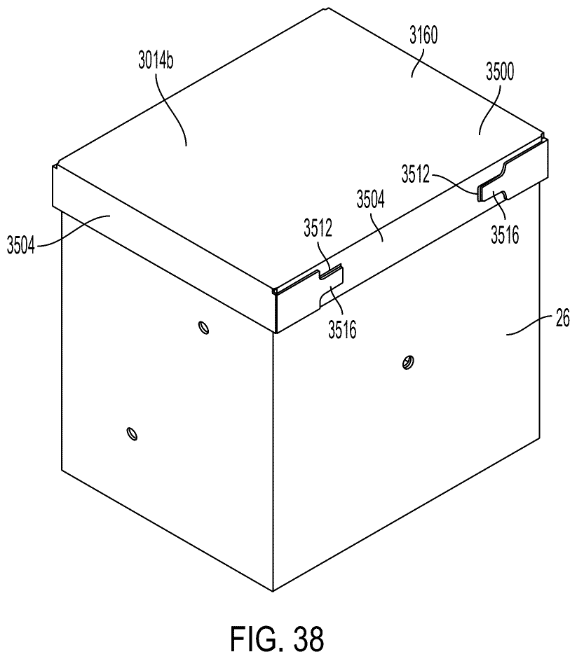

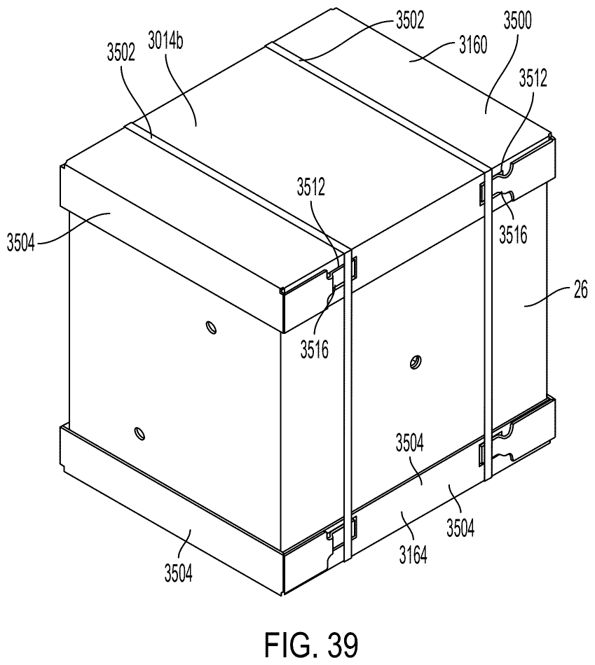

FIGS. 38-40 illustrate another embodiment of the top travel cap 3160 and the bottom travel cap 3164. The travel caps 3160, 3164 are substantially similar to the travel caps 160, 164 discussed above, respectively, and therefore only the differences will be discussed in detail herein. Each travel cap 3160, 3164 includes a center panel 3500 and a plurality of side panels 3504 extending from the perimeter of the center panel 3500. In the illustrated embodiment, the side panels 3504 extend perpendicular to the center panel 3500 to form the sidewalls 174, 178 of the caps 3160, 3164,

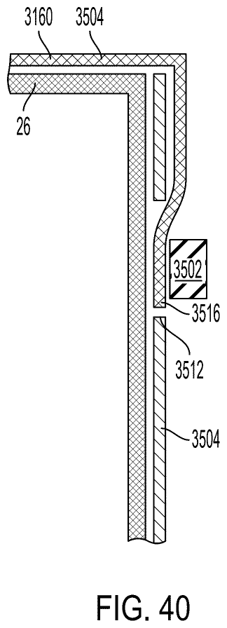

In some embodiments, side panels 3504 that are positioned adjacent to one another may be coupled or otherwise joined together to help maintain the overall shape of the travel caps 3160, 3164. In some embodiments, joining the side panels 3504 together help to make sure that all of the side panels 3504 remain perpendicular to the center panel 3500. In some embodiments, the resulting connection includes a pocket 3512 formed into one side panel 3504 and a tongue 3516 formed into the adjacent side panel 3504. As shown in FIGS. 38 and 40, the pocket 3512, in turn, is open to the exterior of the side panel 3504 and is sized and shaped so that at least a portion of the tongue 3516 may be positioned therein.

When assembled, the tongue 3516 is compressed into the pocket 3512 (e.g., via a strap 3502, adhesive, and the like) such that interference between the tongue 3516 and the side walls of the pocket 3512 fixedly secure the relative position of the two adjacent side panels 3504. In embodiments where the straps 3502 are used to compress the tongue 3516 into the pocket (see FIG. 40), the connection has the added advantage that when the straps 3502 are cut to open the container 3014b, the tongue 3516 is free to leave the pocket 3512, allowing the side panels 3504 of the caps 3160, 3164 to move and for the caps 3160, 3164 to be removed more easily from the inner structural layer 26.

1. A food container configured to store a foodstuff therein, the food container comprising:
an inner structural layer at least partially defining an internal volume in which the foodstuff may be positioned; and
an outer structural layer located outside the inner structural layer relative to the internal volume, wherein the outer structural layer is adjustable between an installed position, in which the outer structural layer encompasses and provides structural support to the inner structural layer, and a detached position where the outer structural layer does not encompass and does not provide structural support to the inner structural layer, and wherein the outer structural layer is adjustable between the installed position and the detached position.

2. The food container of claim 1, wherein the outer structural layer is adjustable between the installed position and the detached position without having to remove the foodstuff from the internal volume.

3. The food container of claim 1, wherein the inner structural layer is formed from a paperboard material.

4. The food container of claim 1, wherein the outer structural layer is formed from a metallic material.

5. The food container of claim 1, wherein the inner structural layer defines an exterior shape, and wherein the outer structural layer includes an inner shape that corresponds with the exterior shape when the outer structural layer is in the installed position.

6. The food container of claim 1, wherein the outer structural layer is in direct contact with the inner structural layer when the outer structural layer is in the installed position.

7. The food container of claim 1, wherein the inner structural layer includes two pieces of material coupled together to form the internal volume.

8. A disposable container configured to contain foodstuff therein, the disposable container comprising:
a body including a plurality of panels, wherein the body defines an interior volume in which foodstuff may be placed, wherein the interior volume is open on a first end, and wherein at least two of the panels overlap; and
a first end cap couplable to the body, wherein the first end cap is configured to enclose the first end.

9. The disposable container of claim 8, further comprising a liner at least partially positioned within the internal volume, wherein the liner is positioned to form a barrier between the foodstuff and the plurality of panels.

10. The disposable container of claim 8, wherein the plurality of panels are formed from two U-shaped segments.

11. The disposable container of claim 8, wherein the body and the first end cap are both formed from a paperboard material.

12. The disposable container of claim 11, wherein the paperboard material is approximately ¼″ thick.

13. The disposable container of claim 8, wherein at least one panel defines a sample port open to the internal volume.

14. The disposable container of claim 8, wherein at least two panels of the plurality of panels are formed from a single piece of material.

15. The disposable container of claim 8, wherein the first end cap includes a base plate and one or more side plates extending from the perimeter of the base plate to define a first end cap volume, and wherein the first end of the body is positioned within the first end cap volume.

16. The disposable container of claim 8, wherein the interior volume is open on a second end opposite the first end, the container further comprising a second end cap couplable to the body and configured to enclose the second end.

17. The disposable container of claim 8, further comprising a first plurality of panels, and wherein the first plurality of panels are removably positionable around the exterior of the body.

18. A container configured to contain foodstuff therein, the container comprising:
a first segment including two or more panels formed from a single piece of material;
a second segment including two or more panels formed from a single piece of material, wherein the first segment and the second segment define an interior volume that is open on at least one end.

19. The container of claim 18, wherein the first segment includes three panels separated by two joints.

20. The container of claim 18, wherein the first segment includes a first central panel, a first side panel adjacent the first central panel, and a second side panel adjacent the first central panel opposite the first side panel,
wherein the second segment includes a second central panel, a third side panel adjacent the second central panel, and a fourth side panel adjacent the second central panel opposite the third side panel, and
wherein the first segment is coupled to the second segment such that the first side panel overlaps the third side panel and where the second side panel overlaps the fourth side panel.
